(19) United States
(12) Patent Application Publication
(10) Pub. No.: US 2021/0181527 A1
(43) Pub. Date: Jun. 17, 2021

(54) MULTI-MOLDED EYEWEAR APPARATUS

(71) Applicant: H2W, Chatsworth, CA (US)

(72) Inventor: David Levich, West Hills, CA (US)

(21) Appl. No.: 17/116,692

(22) Filed: Dec. 9, 2020

Related U.S. Application Data
(60) Provisional application No. 62/946,842, filed on Dec. 11, 2019.

(51) Int. Cl. G02C 5/00; B29D 12/02

(52) U.S. Cl. CPC G02C 5/008; B29K 2105/0032; B29D 12/02

(57) ABSTRACT

An eyewear apparatus uses a multi-molded design in which a structural component of the eyewear apparatus (e.g., frame) is constructed from multiple molded layers fitted together to appear as a single structural component. For example, a base molded layer of the structural component may include a recessed channel into which an additional molded layer of the structural component may be fitted and affixed. The additional molded layer may be designed such that when the additional molded layer is affixed within the recessed channel of the base molded layer, the base molded layer and the additional molded layer of the structural component appear as a singularly molded physical component. To provide varying designs and/or colors, each molded layer (e.g., the base molded layer and the additional molded layer), may be constructed using a different material, color of material, and/or plating.

### CROSS-REFERENCE TO RELATED APPLICATIONS

This application claims the benefit of priority of U.S. Provisional Application No. 62/946,842, filed on Dec. 11, 2019, which is incorporated herein by reference in its entirety.

### BACKGROUND

Conventional eyeglasses are used to protect and/or enhance a user's vision. For example, sunglasses include a frame to house tinted lenses for protecting a user's eyes from the sun. Likewise, eyeglasses may include prescription lenses to correct a user's vision. Some conventional glasses may also provide aesthetic features to enhance a user's appearance. For example, eyeglass frames may be shaped in a decorative fashion, such as a cat-eye or rounded shape, to enhance the user's physical appearance. While the shape of the frame may be molded to provide some fashionable variation, current methods provide limited options for modifying the design or colors of the frame itself. For example, eyeglass frames are molded from a single material and are therefore limited to the color and appearance of the material uses. Generally, these materials provide a single solid color (e.g., black, white, green, blue, etc.), or a limited pattern, such as tortoise shell. To add additional color or design to the frame, current options are limited to use of accent pieces affixed to the frame or printing/painting onto the frame. Accent pieces appear separate from the frame, which is not desirable for some designs. Further, printed or painted designs added to the frame may be difficult to implement and often degrade over time. Accordingly, improvements are needed.

### BRIEF DESCRIPTION OF THE DRAWINGS

Various ones of the appended drawings merely illustrate example embodiments of the present disclosure and are not intended to limit its scope to the illustrated embodiments. On the contrary, these examples are intended to cover alternatives, modifications, and equivalents as may be included within the scope of the disclosure.

FIG. 1 shows a perspective view of an eyewear apparatus for depicting a character, according to some example embodiments.

FIGS. 2A-2C show an eyewear apparatus constructed utilizing a multi-molded design, according to some example embodiments.

FIG. 3 is a flowchart showing an example method of constructing an eyewear apparatus using a multi-molded design.

FIG. 4 shows additional examples of an eyewear apparatus constructed utilizing a multi-molded design, according to some example embodiments.

### DETAILED DESCRIPTION

Aspects of the subject technology address the problems of conventional eyewear implementations, which provide limited options for varying the designs and/or colors of structural components used to construct an eyewear apparatus. In particular, aspects of the technology provide a multi-molded design in which a structural component of an eyewear apparatus (e.g., frame) may be constructed from multiple molded layers fitted together to appear as a single structural component. For example, a base molded layer of the structural component may include a recessed channel into which an additional molded layer of the structural component may be fitted and affixed. The additional molded layer may be designed such that when the additional molded layer is affixed within the recessed channel of the base molded layer, the base molded layer and the additional molded layer of the structural component appear as a singularly molded physical component.

To provide varying designs and/or colors, each molded layer (e.g., the base molded layer and the additional molded layer), may be constructed using a different material, color of material, and/or plating. For example, the base molded layer may be electroplated with a gold plating, while the additional molded layer may be electroplated with a silver plating. Affixing the additional molded layer within the recessed channel of the base molded layer results in a seemingly singularly molded structural component that appears to be partially electroplated with both gold plating and silver plating.

A base molded layer may include multiple recessed channels, into which different additional molded layers may be fitted and affixed. Accordingly, multiple additional molded layers may be fitted and affixed into a single base molded layer. Each additional molded layer may be constructed using a different material, color of material, and/or plating to provide additional design variation to the eyewear apparatus. Further, an additional molded layer may also include a recessed channel into which another additional molded layer may be fitted and affixed. In this type of embodiments, a singular layer of the structural component may be both an additional molded layer configured to be fitted and affixed into a base molded layer, as well a base molded layer including a recessed channel into which another additional molded layer may be fitted and affixed.

Use of a multi-molded design provides a solution to shortcomings of current manufacturing techniques because each molded layer provides the benefit of being manufactured separately, while appearing as a singular physical component when combined. This allows for multiple textures, colors and/or materials to be integrated into the design of a physical component without use of accent pieces or printing.

The multi-molded design may be implemented in relation to any structural component used to construct an eyewear apparatus, such as the frame, earpieces, etc. For example, the multi-molded design may be used in relation to an additional structure of an eyewear apparatus that is used to alter an appearance of a user when the eyewear apparatus is worn by the user. For example, the additional structure may depict the likeness of a character, which allows a user wearing the eyewear apparatus to embody the character's likeness. The additional structure may resemble any portion of a character (e.g., popular television, cartoon character, or animal), such as a face of the character, hair of the character, headwear worn by the character, mask worn by the character, etc. Although, the location of the additional structure in relation to the frame can vary depending on implementation, in some embodiments, the additional structure is located substantially on the top of the frame such that the additional structure conceals the forehead of a user when the user is wearing the eyewear apparatus. In some embodiments, the additional structure may be located at any point along the frame, however, in some embodiments, the additional structure is located on the top or the sides of the frame, such that the additional structure does not interfere with the user's ability to see out of the eyewear apparatus.

The multi-molded design may be utilized to create any type of desired pattern, shape or design within a structural component of the eyewear apparatus. For example, the multi-molded design may be used to create an outline along edges of a structural component of the eyewear apparatus, such as an outline to the frame. As another example, the multi-molded design may be used to depict a portion of a character, such as by depicting and/or outlining a feature of the character, such as an eye, mouth, eyebrow, hair, etc., of the character. Further, the multi-molded design may be used to portray an expression of the character, which allows an individual wearing the eyewear apparatus to embody a particular emotion or expression. For example, the multi-molded design may be used to depict features shaped in a particular way to portray an emotion, such as eyebrows tilted downwards towards a nose of a depicted character or user to portray anger.

As explained earlier, electroplating can used to deposit material on to the substrate material of any structural component and/or molded layer used to construct an eyewear apparatus. For example, electroplating can used to deposit material on to the substrate material of the frame, additional structure, base molded layer, and/or additional molded layer used to construct an eyewear apparatus.

In some embodiments, the electroplating (also called “electrodeposition” or “plating”) process uses electric current to reduce dissolved metal cations (e.g., positively charged ions) so that the cations form a metal coating on an electrode. An electrode can be understood as an electrical conductor used to make contact with a nonmetallic part of a circuit (e.g., a semiconductor, an electrolyte, a vacuum or air). Electroplating, in an example, is used to change the surface properties of an object (e.g., abrasion and wear resistance, corrosion protection, lubricity, aesthetic qualities, etc.), and also can be used to build up thickness on parts or to form objects by electroforming. While the above example, of electroplating or plating is describe, any method of electroplating or plating may be used.

Similar to the electroplating described above for conductive materials, plating of nonconductive materials (e.g., plastic, polycarbonate, glass, wood, etc.) is also contemplated by embodiments described herein. In an example, a non-conductive material is metalized by etching the surface of the material and coating the etched surface with a first conductive material (e.g., a metal such as copper or nickel). Subsequently, an electroplating process may be used to further coat the now metalized material with another second metal such as gold, nickel, copper, or chrome.

Plating may be utilized for forming a metal coating on a physical component and/or molded layer used to construct an eyewear apparatus. For example, various metals, such as copper, gold, silver or nickel, may be used to modify the surface of a physical component and/or molded layer to provide a desired appearance or aesthetic, which may introduce reflective properties. Further, electroplating can be used to deposit the same material or different materials on the various structural components and/or molded layers. For example, plating of the base molded layer and/or the additional molded layer can be performed using different metals and materials to help define a design, such as a portion of a character, outline, etc.

Advantages of using electroplating include added aesthetic appeal and surface protection from corrosion and other types of damage. One drawback with using electroplating is that different portions of a single structural component cannot be electroplated with different materials. Use of the multi-molded design alleviates this issue, as each molded layer (e.g., base molded layer and additional molded layer) can be electroplate separately with different metals and then combined to create the appearance of a singular structural component.

Reference will now be made in detail to specific example embodiments for carrying out the inventive subject matter of the present disclosure. In the following description, specific details are set forth in order to provide a thorough understanding of the subject matter. It shall be appreciated that embodiments may be practiced without some or all of these specific details.

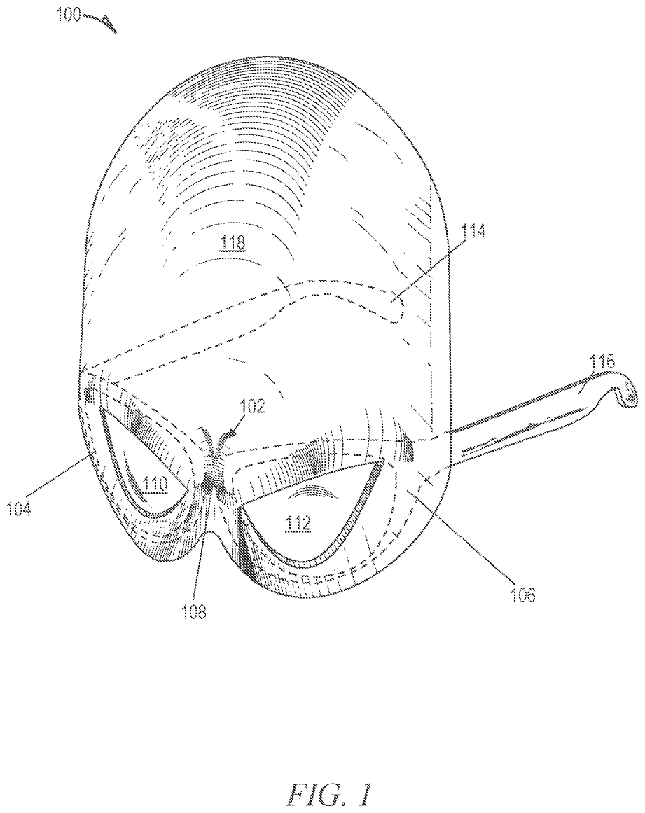

FIG. 1 shows a perspective view of an eyewear apparatus 100 for depicting a character, according to some example embodiments, The eyewear apparatus 100 includes a frame 102 comprising a first eyepiece 104 and a second eyepiece 106 connected by a bridge portion 108 of the frame 102. The first eyepiece 104 and the second eyepiece 106 each include an aperture in which a lens can be disposed. As shown, a first lens 110 is disposed within the aperture of the first eyepiece 104, and a second lens 112 is disposed within the aperture of the second eyepiece 106. The first lens 110 and the second lens 112 can be any type of known lens used for eyewear, such as tinted lenses, prescription lenses, clear lenses, bifocal lenses, etc. Each lens 110 and 112 may be constructed of a suitable material such as glass, plastic, composites, etc., and in some embodiments may be tinted and/or include UV (ultraviolet) light protection.

The eyewear apparatus 100 further includes a first earpiece 114 coupled to the first eyepiece 104, and a second earpiece 116 coupled to the second eyepiece 106. The first earpiece 114 and the second earpiece 116 can be coupled to the first eyepiece 114 and the second eyepiece 106 using any known technique, such as by screws, glue, hinge, etc.

The eyewear apparatus 100 is configured to be fitted around a user's face such that the first earpiece 114 is supported by a first ear of the user, the second earpiece 116 is supported by a second ear of the user, and the bridge portion 118 of the frame 102 is supported by a nose of the user. When the eyewear apparatus 100 is fitted around a user's face, the first eyepiece 104 and the second eyepiece 106 are aligned with the user's eyes to allow the user to see through the first lens 110 disposed within the first eyepiece 104 and the second lens 112 disposed within the second eyepiece 106.

The eyewear apparatus 100 further includes an additional structure 118 that is coupled to the frame 102, such that the additional structure 118 covers a portion of a forehead of the user when the eyewear apparatus 100 is fitted around the face of the user. The additional structure 118 can depict a portion of a character, For example, the additional structure 118 can resemble a character's mask, face, etc., such that the first lens 110 and the second lens 112 represent the character's eyes and/or eye slots in the character's mask.

The additional structure 118 may be coupled to the frame 102 using any suitable method. For example, the additional structure 118 may be coupled to the frame 102 using screws or an adhesive material (e.g., glue) to attach the additional structure 118 to the frame 102. In another embodiment, the additional structure 118 and the frame 102 may be coupled by forming the additional structure 118 and frame 102 together as a single piece included in the eyewear apparatus 100.

The additional structure 118 may depict a portion of a character, a character's mask, a helmet worn by a character, etc. A user may fit the eyewear apparatus 100 around the user's face to create the illusion that the user is wearing the character's mask and/or is the character. The additional structure 118 can be designed in any desired shape to properly depict a character, character's mask, character's helmet, etc.

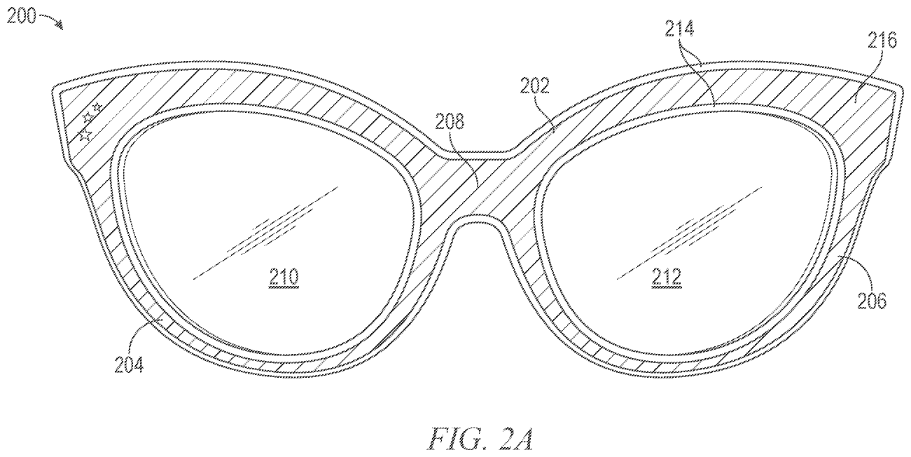

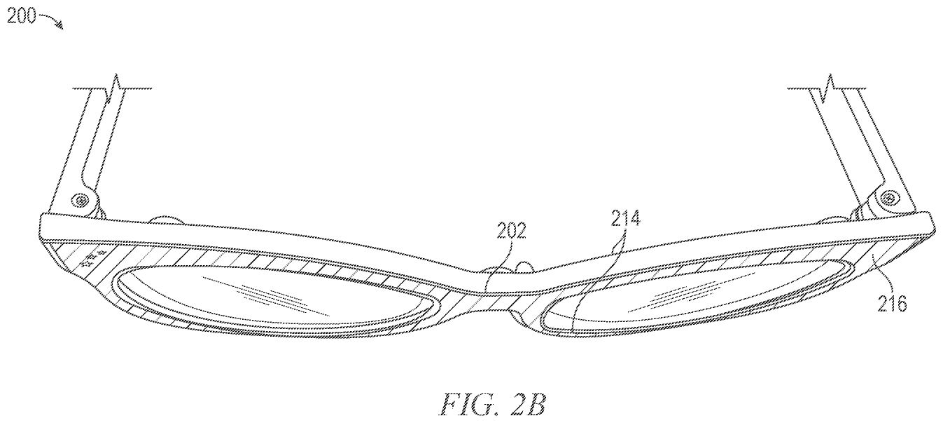

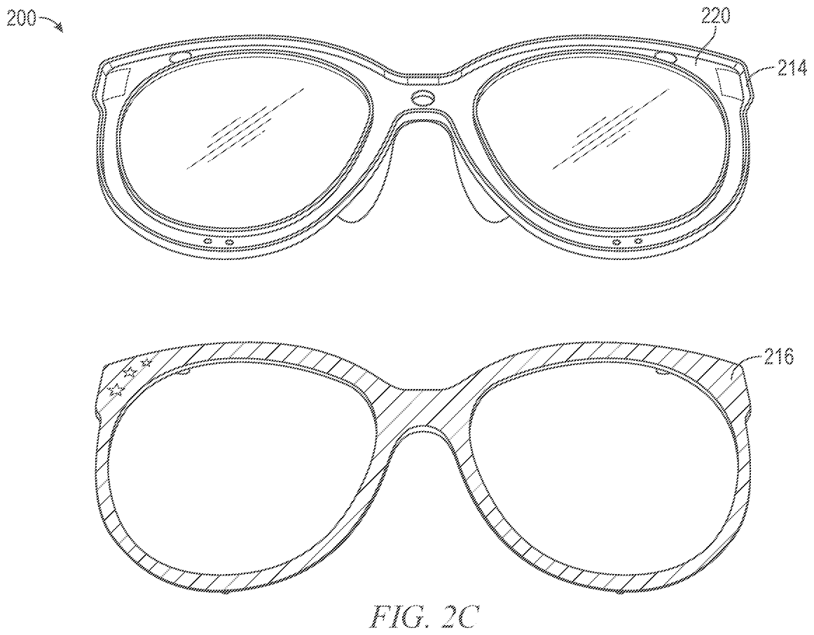

As explained above, a multi-molded design may be implemented to construct any physical structure of the eyewear apparatus 100. For example, the multi-molded design may be used to construct the frame 102, the first earpiece 114, the second earpiece 116, and/or the additional structure 118. Although the eyewear apparatus 100 shown in FIG. 1 depicts includes an additional structure 118 and depicts the likeness of a character, this is just one example and is not meant to be limiting. The multi-molded design may be implemented in relation to physical components of any type of eyewear apparatus, including eyewear apparatuses meant for novelty purposes to depict a character, as well as eyewear apparatuses meant purely for aesthetics and/or vision enhancement purposes. Examples of the multi-molded design used to construct structural components of an eyewear apparatus are shown below in relation to FIGS. 2A-2C.

FIGS. 2A-2C show an eyewear apparatus 200 constructed utilizing a multi-molded design, according to some example embodiments. FIG. 2A shows a front view of the eyewear apparatus 200. The eyewear apparatus 200 includes a frame 202 comprising a first eyepiece 204 and a second eyepiece 206 connected by a bridge portion 208 of the frame 202. The first eyepiece 204 and the second eyepiece 206 each include an aperture in which a lens can be disposed. As shown, a first lens 210 is disposed within the aperture of the first eyepiece 204, and a second lens 212 is disposed within the aperture of the second eyepiece 206.

As shown, the frame 200 is constructed using a multi-molded design. For example, the frame 200 is constructed from a base molded layer 214 and an additional molded layer 216. The base molded layer 214 includes a recessed channel into which the additional molded layer 216 may be fitted and affixed, resulting in a seemingly singular structural component (e.g., frame 202). The additional molded layer 216 may be affixed to the base molded layer 214 using any suitable attachment means, such as with glue, screws, nails, clips, etc.

The base molded layer 214 and the additional molded layer 216 may be manufactured using different materials, colors, and/or plating. For example, as shown, the base molded layer 214 is plated with a metallic gold coating, and the additional molded layer 216 is constructed using a red material. When affixed to each other, the base molded layer 214 and the additional molded layer 216 appear as a singular structural component (e.g., frame 202) that includes different finishes (e.g., gold and red). In the shown example, the base molded layer 214 provides a metallic gold outline to the frame 202, and the additional molded layer 216 provides a red interior within the metallic gold outline. FIG. 2B shows a top view of the eyewear apparatus 200. As shown, the base molded layer 212 provides a border to the frame 202, within which the additional molded layer is fitted.

FIG. 2C shows an exploded view of the eyewear apparatus 200. As shown, the base molded layer 214 includes a recessed channel 218 into which the additional molded layer 216 can be fitted and affixed to create a seemingly singular structural component (e.g., frame 202). While the recessed channel 218 in the shown example is on a front side of the base molded layer 214, in some embodiments, the recessed channel 218 or another recessed channel 218 may be included on the back side of the base molded layer 214. One advantage of utilizing a multi-molded design is that the cost and difficulty associated with production is reduced. For example, by manufacturing the base molded layer 214 and additional molded layer 216 separately, each may be constructed using a different material, color, and/or plating, which greatly simplifies the process of incorporating multiple colors, designs and/or materials into a singular structural component used to construct an eyewear apparatus 200. Further, once the molds for constructing the base molded layer 214 and additional molded. layer 216 are completed, the base molded layer 214 and additional molded layer 216 may be each manufactured using different materials, colors, and/or plating to create various versions of the structural component.

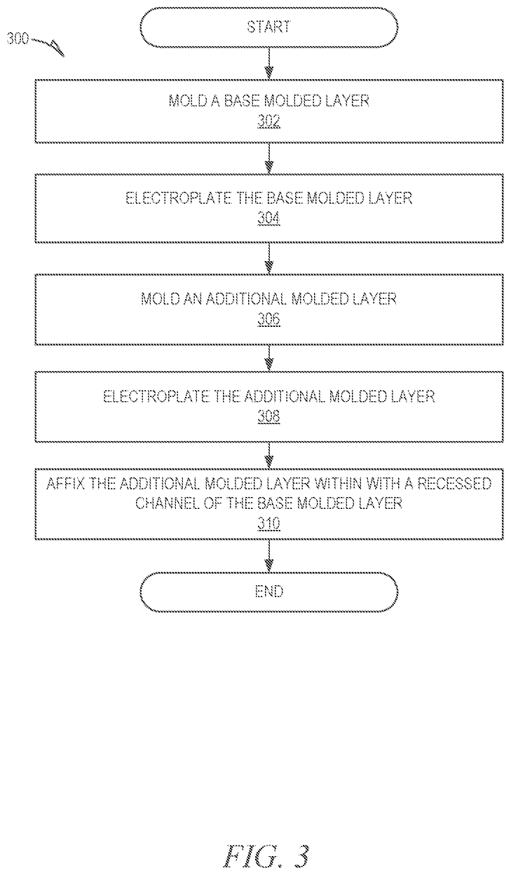

FIG. 3 is a flowchart showing an example method 300 of constructing an eyewear apparatus 200 using a multi-molded design.

At step 302, a base molded layer 214 is molded. The base molded layer 214 may be molded using any suitable material, such as plastic, metal, etc. The material used to mold the base molded layer 214 may be any desired color or include any desired texture or finish. The base molded layer 214 may include a recessed channel 218 into which an additional molded layer 216 may be fitted and affixed.

At step 304, the base molded layer 214 is electroplated using first plating. For example, the base molded layer 214 may be electroplated with a gold plating, silver plating, etc. Step 304 is an optional step. In some embodiments, the base molded layer 214 is not electroplated.

At step 306, an additional molded layer 216 is molded. The additional molded layer 216 may be molded using any suitable material, such as plastic, metal, etc. The material used to mold the additional molded layer 216 may be any desired color or include any desired texture or finish, including the same or different color, texture, or finish used to mold the base molded layer 214. The additional molded layer 216 is designed (shaped, sized) to be fitted and affixed within the recessed channel 218 of the base molded layer 214.

At step 308, the additional molded layer 216 is electroplated using a second plating. For example, the additional molded layer 216 may be electroplated with a gold plating, silver plating, etc., that is different than the first plating used in relation to the base molded layer 214. Step 308 is an optional step. In some embodiments, the additional molded layer 216 is not electroplated.

At step 310, the additional molded layer 216 is fitted and affixed within the recessed channel 218 of the base molded layer 214. Affixing the additional molded layer 216 within the recessed channel 218 of the base molded layer 214 results in a seemingly singular structural component (e.g., frame 202, first earpiece 204, second earpiece 206, additional structure 118, etc.) which includes different colors, textures, and/or plating.

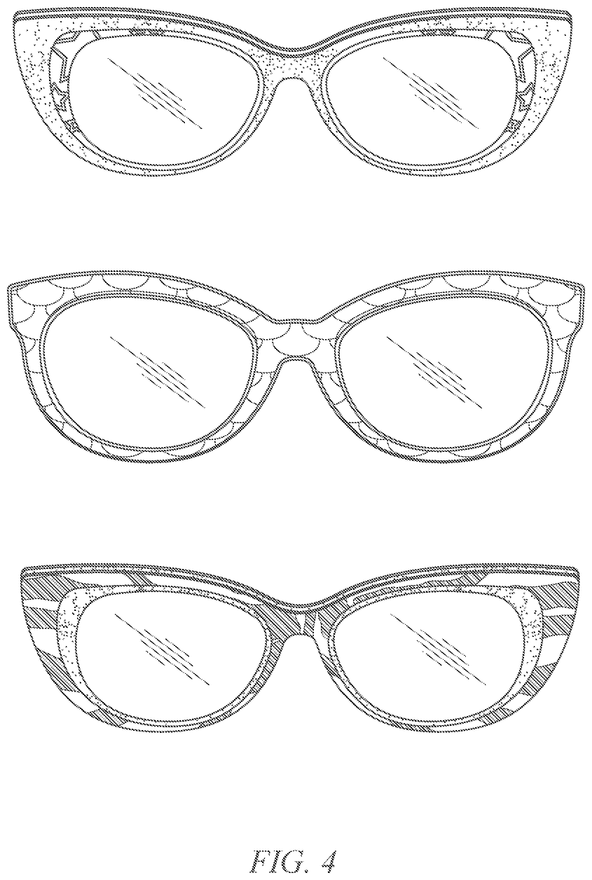

FIG. 4 shows additional examples of an eyewear apparatus constructed utilizing a multi-molded design, according to some example embodiments. Three additional embodiments are shown, in which a multi-molded design is used. The shown embodiments include varying sizes, thicknesses and shapes of the base molded layers and additional molded layers. Further a variety of material colors and designs are used in the different layers (e.g., base molded layers and additional molded layers) of each embodiments.

Although the embodiments of the present invention have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent, to those of skill in the art, upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated references should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim.

What is claimed is:

1. An eyewear apparatus comprising:
a frame including a first eyepiece and a second eyepiece, the frame comprising a base molded layer including a first recessed channel, and a first additional molded layer fitted within the first recessed channel and affixed to the base molded layer;
a first earpiece coupled to the first eye piece; and
a second earpiece coupled to the second eye piece, wherein the frame is configured to be fitted around the face of a user such that the first earpiece is supported by a first ear of the user and the second earpiece is supported by a second ear of the user.

2. The eyewear apparatus of claim 1, wherein the base molded layer is electroplated using a first plating material.

3. The eyewear apparatus of claim 2, wherein the first additional molded layer is electroplated using a second plating material that is different than the first plating material.

4. The eyewear apparatus of claim 1, wherein the base molded layer includes a second recessed channel, and a second additional molded layer is fitted within the second recessed channel and affixed to the base molded layer.

5. The eyewear apparatus of claim 4, wherein the first additional molded layer is a first color and the second additional molded layer is a second color.

6. The eyewear apparatus of claim 5, wherein the first additional molded layer is electroplated using a first material.

7. The eyewear apparatus of claim 5, wherein the first additional molded layer is formed using a first material and the second additional molded layer is formed using a second material that is different than the first molded material.

8. The eyewear apparatus of claim 5, wherein the base molded layer is a third color, that is different than the first color and the second color.

9. The eyewear apparatus of claim 1, wherein the first additional molded layer includes a second recessed channel, and a second additional molded layer is fitted within the second recessed channel and affixed to the first additional molded layer.

10. The eyewear apparatus of claim 9, wherein the first additional molded layer is electroplated using a first plating and the second the additional molded layer is electroplated using a second plating that is different than the first plating.
